(19) United States
(12) Patent Application Publication
(10) Pub. No.: US 2005/0179355 A1
(43) Pub. Date: Aug. 18, 2005

(54) Composition for forming an electron emission source for use in an electron emission device and an electron emission source prepared therefrom

(76) Inventors: Seung-Joon Yoo, Suwon-si (KR); Jae-Myung Kim, Suwon-si (KR); Joong-Woo Nam, Suwon-si (KR); Su-Kyung Lee, Suwon-si (KR); Jong-Woon Moon, Suwon-si (KR); Hyun-Jung Lee, Daejeon-si (KR)

Correspondence Address: CHRISTIE, PARKER & HALE, LLP, PO BOX 7068, PASADENA, CA, 91109-7068, US

(21) Appl. No.: 11/031,676

(22) Filed: Jan. 7, 2005

(30) Foreign Application Priority Data
Jan. 9, 2004 (KR) 10-2004-0001476

(51) Int. Cl. H01J 1/00; H01J 1/14; H01J 1/38

(52) U.S. Cl. 313/311; 313/310; 313/346 R

(57) ABSTRACT

The present invention relates to a composition for forming an electron emission source for use in an electron emission device and an electron emission source prepared therefrom. The composition comprises an organic binder resin, a carbon-based material, a solvent and a silane-based compound. Also provided is a photosensitive composition for forming an electron emission source comprising an organic binder resin, a carbon-based material, a solvent, a photosensitive component selected from the group consisting of photosensitive monomers, photosensitive oligomers and photosensitive polymers, a photoinitiator and a silane-based compound of the general form R′—SiR₃, where R is selected from the group consisting of alkoxys, alkyls, chloro, fluoro and bromo, and R′ is selected from the group consisting of vinyl, epoxy, methacryl, amino, mercapto and 2-(3,4-epoxycyclohexyl)ethyl. The composition imparts superior adhesive force, thereby increasing the effective radiation area, and improving the electron emission efficiency of the electron emission device.

### CROSS-REFERENCE TO RELATED APPLICATION

This application claims priority of Korean Patent Application No. 10-2004-0001476, filed Jan. 9, 2004, the entire disclosure of which is incorporated herein by reference.

### FIELD OF THE INVENTION

The present invention relates to a composition for forming an electron emission source for use in an electron emission device and an electron emission source prepared therefrom, and more particularly to a composition for forming an electron emission source for use in an electron emission device having good electron emission efficiency, superior adhesive force and improved effective radiation area, and an electron emission source prepared therefrom.

### BACKGROUND OF THE INVENTION

Earlier electron emission sources for use in electron emission devices comprised spindt-type electron emission sources including one of molybdenum, silicon, etc., with sharp tips of sub-micron size. However, since the spindt-type electron emission source has an ultra-fine structure, the method of fabricating it is very complicated and requires a great deal of attention. Therefore, it is limited in producing large-sized field emission devices.

Accordingly, carbon-based materials have recently emerged as potentially useful electron emission sources due to their low work function. One carbon material, carbon nanotube (CNT), is particularly expected to be an ideal electron emission source since it features a high aspect ratio and a small tip radius of curvature of about 100 Å, and therefore electrons are readily emitted by an external voltage of as low as 1 to 3 V/μm.

Generally, the carbon material such as carbon nanotube is fabricated into an electron emission source by forming it into a paste along with glass frit, solvent, an organic binder resin and so on. The paste is applied on a cathode by screen printing, and is then sintered under an air atmosphere at a temperature of 400° C. or higher. Since carbon nanotube features a low work function, the resultant electron emission source can be driven by low voltages, and the method of fabricating it is not complicated. Hence, it offers advantages for large-sized display panels. However, carbon materials are generally very unstable at temperatures of 400° C. or higher and in the presence of oxygen, and a lot of carbon nanotube is lost during sintering. This results in a reduced number of sites contributing to emission, which makes the carbon nanotube unsuitable for use as an electron emission source.

In general, carbon based materials have a low film adhesive force when adhered to ITO oxides or metals used as cathodes and the carbon materials tend to drop off because of a strong electric field from the anode during field emission in the device. The result is reduced emission capability and life cycle of the electron emission device.

A method of fabricating a thick film electron emission source (emitter) by fixing the solid content of carbon nanotube powder and glass frit at 4:1 is known. However, if the solid content is increased to increase the film thickness after sintering, the relative content of the carbon nanotube increases greatly, and the exposed part of the carbon nanotube paste becomes too thin. Accordingly, it is difficult to increase the content of the carbon nanotube to obtain a high emission current density.

In an attempt to solve this problem, a method of fixing the glass frit content and increasing the carbon nanotube content has been proposed. However, when an electron emission source is fabricated using the resultant carbon nanotube paste, the exposure thickness decreases and the amount of the carbon nanotube remaining after sintering decreases, so that it is difficult to obtain a carbon nanotube electron emission source having an ideal thickness. Also, a method of adding fine metal powders when manufacturing an electron emission device comprising a thick film electron emission source to increase the adhesive force and conductivity of the thick film has been proposed. However, if the thick film surface is covered by the fine metal powders, the field emission capability is not fully realized.

Korean Patent Application No. 2000-57116 discloses a method of exposing the carbon nanotube on the surface during developing using a photosensitive resin. Also, U.S. Pat. No. 5,026,624 discloses a method of preparing an epoxy based photosensitive resin as such a photosensitive resin. However, this method requires stabilization time to stabilize the photosensitive material against field emission. Additionally, U.S. Pat. No. 5,912,106 discloses a method of improving image quality and resolution of a field emission device using a photocurable resin as a photoinitiator.

### SUMMARY OF THE INVENTION

In one embodiment of the present invention, a composition is provided for forming an electron emission source for use in an electron emission device, the electron emission source having superior adhesive force and an increased effective radiation area, thereby offering superior electron emission efficiency.

In another embodiment of the present invention an electron emission source is formed using the composition for forming an electron emission source.

In yet another embodiment of the present invention an electron emission device comprising the electron emission source is provided.

### BRIEF DESCRIPTION OF THE DRAWINGS

FIG. 1 is a partial cross-sectional view of an electron emission device according to one embodiment of the invention.

### DETAILED DESCRIPTION

The present invention provides a composition for forming an electron emission source comprising an organic binder resin, a carbon-based material, a solvent and a silane-based compound represented by the following Formula 1:
R′—SiR₃ (1)
where R is selected from the group consisting of alkoxys, alkyls, chloro, fluoro and bromo and R′ is selected from the group consisting of vinyl, epoxy, methacryl, amino, mercapto and 2-(3,4-epoxycyclohexyl)ethyl.

The present invention also provides a composition for forming an electron emission source comprising a carbon-based material; a solvent; a photosensitive component selected from the group consisting of a photosensitive monomer, a photosensitive oligomer and a photosensitive polymer; a photoinitiator; and a silane-based compound represented by the following Formula 1:
R′—SiR₃ (1)
where R is selected from the group consisting of alkoxys, alkyls, chloro, fluoro and bromo, and R′ is selected from the group consisting of vinyl, epoxy, methacryl, amino, mercapto and 2-(3,4-epoxycyclohexyl)ethyl. In one embodiment, the alkoxy or alkyl has 1 to 10 carbon atoms, and in another embodiment the preferred alkoxy is selected from the group consisting of methoxy, methoxyethoxy, ethoxy and propoxy.

The present invention also provides an electron emission source formed by print-coating the composition for forming an electron emission source and electron emission device comprising the same. The electron emission device is preferably a field emission display.

Hereinafter, the present invention is described in more detail.

The composition for forming an electron emission source according to the present invention comprises an organic binder resin, a carbon-based material, a solvent and a silane-based compound represented by Formula 1.

The organic binder resin may be any one commonly used in an electron emission source for use in an electron emission device. Nonlimiting examples of suitable organic binder resins include acryl-based resins, epoxy-based resins and cellulose-based resins such as ethyl cellulose and nitrocellulose.

Preferably, the organic binder resin is present in an amount ranging from 5 to 60 parts by weight based on the total weight of the composition. If the content of the organic binder resin is below 5 parts by weight, the composition is not printed properly because the flowability becomes poor and pattern formation becomes difficult. If the content of the organic binder resin exceeds 60 parts by weight, the same problems arise, i.e., the composition becomes too viscous, so that the composition is not printed properly because the flowability becomes poor and pattern formation becomes difficult.

The carbon-based material may be any one commonly used in an electron emission source for use in an electron emission device. Nonlimiting examples of suitable carbon-based materials include carbon nanotube, graphite, diamond, diamond like carbon (DLC) and fullerene (C60). The carbon-based material is preferably present in an amount ranging from 1 to 20 parts by weight based on the total weight of the composition. If the content of the carbon-based material is below 1 part by weight, the emission current density may decrease. If it exceeds 20 parts by weight, the thickness of the obtained film may be undesirable since the intensity of the UV rays transmitted through the film during exposure decreases.

Nonlimiting examples of suitable solvents include butyl cellosolve (BC), butyl carbitol acetate (BCA), terpineol (TP), toluene, texanol, etc. The solvent is preferably present in an amount ranging from 30 to 60 parts by weight based on the total weight of the composition. If the content of the solvent is below 30 parts by weight, the composition becomes too viscous, so that it is not printed properly. On the other hand, if the content of the solvent exceeds 60 parts by weight, the viscosity of the composition becomes too low.

The silane-based compound enhances the adhesive force of the electron emission source, thereby obtaining uniform exposure pattern formation, uniform field emission and improved emission current. The R group of the silane-based compound, R′—SiR₃, improves the adhesive force to the substrate, and the R′ group reacts with the photosensitive polymer matrix, thereby also improving the adhesive force. Also, the silane-based compound directly reacts with the photosensitive component to improve the adhesive force of the exposed part, thereby improving pattern quality. The silane-based compound turns into silica during fluorescent film formation by heat treatment. The resultant silica may increase surface hardness of the fluorescent film.

Nonlimiting examples of suitable silane-based compounds include vinyltrimethoxyethoxysilane, vinyltrimethylsilane, vinyltrimethoxysilane, vinyltriethoxysilane, ethyltrichlorosilane, vinyltrichlorosilane, γ-methacryloxypropyltrimethoxysilane, γ-methacryloxypropylmethyldimethoxysilane, γ-aminopropyltriethoxysilane, N-aminoethyl-aminopropyl-trimethoxysilane, 2-(3,4-epoxycyclohexyl)ethyl-trimethoxysilane, N-aminoethyl-aminopropyl-trimethoxysilane, 2-(3,4-epoxycyclohexyl)ethyltrimethoxysilane and vinyl-tris(2-methoxyethoxy)-silane and so on. The silane-based compound is preferably present in an amount ranging from 0.1 to 20 parts by weight, more preferably 0.1 to 10 parts by weight based on the total weight of the composition. If the content of the silane-based compound is below 0.1 parts by weight, improvement of adhesive force is slight. If it exceeds 20 parts by weight, the composition is not printed properly.

Since the composition for forming an electron emission source according to the present invention comprises the silane-based compound, an electron emission source can be fabricated without using a glass frit. The electron emission source may further comprise a glass frit to improve adhesive force. The glass frit may be based on PbO—SiO₂, PbO—B₂O₃—SiO₂, ZnO—SiO₂, ZnO—B₂O₃—SiO₂, Bi₂O₃—SiO₂ or Bi₂O₃—B₂O₃—SiO₂. These glass frit components may be used alone or in combination.

The composition for forming an electron emission source may be screen printed on a cathode to form an electron emission source.

Optionally, an electron emission source pattern may be formed by the photolithographic process. The photosensitive composition for forming an electron emission source used in the photolithographic process comprises a carbon-based material, a solvent, a photosensitive component selected from the group consisting of a photosensitive monomer, a photosensitive oligomer and a photosensitive polymer, a photoinitiator and silane-based compound represented by Formula 1.

The carbon-based material and the solvent are the same as described above.

The photosensitive component may be one or more materials selected from the group consisting of a photosensitive monomer, oligomer, and polymer, and is present in an amount ranging from 5 to 60 parts by weight based on the total weight of the composition. If the content of the photosensitive component is below 5 parts by weight, the exposure sensitivity decreases. If it exceeds 60 parts by weight, the pattern formation characteristics become poor and photoreaction occurs excessively at the surface. As a result, the surface becomes hardened and the exposure film thickness decreases due to UV blocking.

The photosensitive monomer, oligomer or polymer may be based on an acrylate-based monomer. Such a monomer may be selected from the group consisting of epoxy acrylate, polyester acrylate, methyl acrylate, ethyl acrylate, n-propyl acrylate, isopropyl acrylate, n-butyl acrylate, sec-butyl acrylate, iso-butyl acrylate, tert-butyl acrylate, n-pentyl acrylate, allyl acrylate, benzyl acrylate, butoxyethyl acrylate, butoxytriethylene glycol acrylate, cyclohexyl acrylate, dicyclopentanyl acrylate, dicyclopentenyl acrylate, 2-ethylhexyl acrylate, glycerol acrylate, glycidyl acrylate, heptadecafluorodecyl acrylate, 2-hydroxyethyl acrylate, isobornyl acrylate, 2-hydroxypropyl acrylate, isodexyl acrylate, isooctyl acrylate, lauryl acrylate, 2-methoxyethyl acrylate, methoxyethylene glycol acrylate, methoxydiethylene glycol acrylate and combinations thereof. Preferably, the photosensitive monomer is present in an amount ranging from 1 to 20 parts by weight based on the total weight of the composition.

The photosensitive oligomer or the photosensitive polymer may be an oligomer or a polymer having a weight-average molecular weight ranging from 500 to 100,000, which is a polymerization product of compounds having unsaturated carbon-carbon bonds. Nonlimiting examples of suitable photosensitive oligomers or polymers include methacryl polymer, polyester acrylate, trimethylolpropane triacrylate, trimethylolpropane triethoxy triacrylate and cresol epoxy acrylate oligomer. Preferably, the photosensitive oligomer or polymer is present in an amount ranging from 4 to 40 parts by weight based on the total weight of the composition.

The photoinitiator may be at least one material selected from the group consisting of benzophenone, methyl-o-benzoyl benzoate, 4,4-bis(dimethylamino)benzophenone, 4,4-bis(diethylamino)benzophenone, 4,4-dichlorobenzophenone, 4-benzoyl-4-methyldiphenyl ketone, dibenzyl ketone, fluorenone, 2,2-diethoxyacetophenone, 2,2-dimethoxy-2-phenylacetophenone, 2-hydroxy-2-methylpropiophenone, p-t-butyldichloroacetophenone, thioxantone, 2-methylthioxantone, 2-chlorothioxantone, 2-isopropylthioxantone, diethylthioxantone, benzyl dimethyl ketanol, benzyl methoxyethyl acetal, benzoin, benzoin methyl ether, benzoin butyl ether, anthraquinone, 2-t-butyl anthraquinone, 2-amylanthraquinone, β-chloroanthraquinone, anthrone, benzathrone, methylene anthrone, 4-azidebenzalacetophenone, 2,6-bis(p-azidebenzylidene)cyclohexanone, 2,6-bis(p-azidebenzylidene)-4-methylcyclohexanone, 2-phenyl-1,2-butadione-2-(o-methoxycarbonyl)oxime, 2,3-bis(4-diethylaminobenzal)cylopentanone, 2,6-bis(4-dimethylaminobenzal)cyclohexanone, 2,6-bis(4-dimethylaminobenzal)-4-methylcyclohexanone, 4,4-bis(diethylamino)-benzophenone, 4,4-bis(dimethylamino)chalcone, 4,4-bis(diethylamino)chalcone, p-dimethylaminocynnamilidene indanone, p-dimethylaminobenzylidene indanone, 2-(p-dimethylaminophenylvinylene)-isonaphtothiazole, 1,3-bis(4-dimethylaminobenzal)acetone, 1,3-carbonyl-bis(4-diethylaminobenzal)acetone, N-phenyl-N-ethylethanolamine, N-phenylethanolamine, N-tolyldiethanolamine, N-phenylethanolamine, isoamyl dimethylaminobenzoate, isoamyl diethylaminobenzoate, 3-phenyl-5-benzoylthio-tetrazol and 1-phenyl-5-ethoxycarbonylthio-tetrazol. The photoinitiator is preferably present in an amount ranging from 0.05 to 10 parts by weight, and more preferably 0.1 to 5 parts by weight, per 100 parts by weight of the photosensitive component. If the content of the photoinitiator is too low, the photosensitivity may be poor. If it is too high, the remaining ratio of the exposed part may be too small.

The photosensitive composition for forming an electron emission source according to the present invention may further comprise glass frit to improve adhesive force of the electron emission source. The glass frit may be based on PbO—SiO₂, PbO—B₂O₃—SiO₂, ZnO—SiO₂, ZnO—B₂O₃—SiO₂, Bi₂O₃—SiO₂ or Bi₂O₃—B₂O₃—SiO₂. These glass frit components may be used alone or in combination.

The composition for forming an electron emission source according to the present invention may further comprise an unsaturated acid such as unsaturated carboxylic acid to improve developing characteristics after exposure to light. Nonlimiting examples of suitable unsaturated carboxylic acids include acrylic acid, methacrylic acid, itaconic acid, crotonic acid, maleic acid, fumaric acid, vinylacetic acid and acid anydrides thereof.

The composition for forming an electron emission source according to the present invention may further comprise an additive such as an antifoaming agent, a disperser, an antioxidant, a polymerization inhibitor, a plasticizer or a metal powder. These additives are added as required in an appropriate amount. The photosensitive paste composition may further comprise a non-photosensitive resin such as an epoxy-based resin or a cellulose-based resin like ethyl cellulose or nitrocellulose.

The mixing order of each component of the composition is not important, but it is desirable to mix the carbon-based material, the photosensitive component, the photoinitiator and the silane-based compound first, and then add the organic solvent to control viscosity.

The composition is printed on a metal, semiconductor or insulator substrate and heat-treated to obtain an electron emission source for use in an electron emission device having a desired pattern. Printing may be done by spraying, spin coating, screen printing, roll coating or dipping. Heat treatment may be performed at 300 to 500° C. in a vacuum or under a gas atmosphere. The gas atmosphere may include air, nitrogen (N₂), or another inert gas.

The electron emission source of the present invention can be used as a cathode in an electron emission device, and preferably as a cathode of a field emission device.

An electron emission device according to the present invention comprises a first substrate; an electron emission source positioned on the first substrate; a second substrate aligned with and separated from the first substrate by a predetermined distance to form a vacuum container with the first substrate; an anode formed on the side of the second substrate opposing the first substrate; a patterned fluorescent film formed on the anode and emitting light by electrons emitted from the electron emission source; and a patterned black matrix layer formed on the anode.

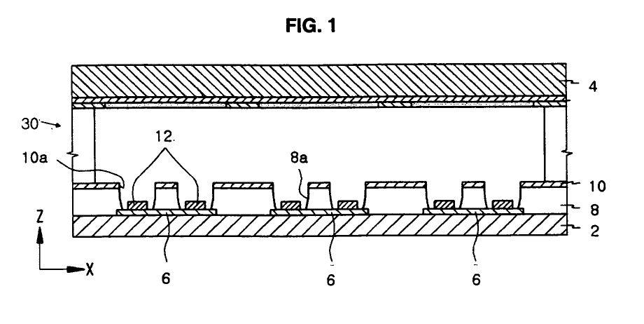

FIG. 1 is a partial cross-sectional view of the electron emission device of the present invention. In the electron emission device, a first substrate (or cathode substrate) 2 and a second substrate (or anode substrate) 4 are aligned parallel to each other at predetermined intervals to form a vacuum container 30.

Inside the vacuum container 30, an electron emission source is positioned on the first substrate and a light emitter is positioned on the second substrate 4 to emit light by electrons emitted from the electron emission source, thereby producing an image.

The electron emission device comprises a cathode 6 formed on the first substrate 2, an insulating layer 8 formed on the cathode 6, a gate electrode 10 formed on the insulating layer 8 and an electron emission source 12 positioned between holes 8a and 10a penetrating the insulating layer 8 and the gate electrode 10 and formed on the cathode 6.

The cathode 6 may be formed along one direction of the first substrate 2 with a patterned shape, e.g. a striped shape. The insulating layer 8 is formed on the first substrate 2, covering the cathode 6.

A plurality of gate electrodes 10 formed on the insulating layer 8 have holes 8a and 10a penetrating the insulating layer 8 and the gate electrode 10. These gate electrodes 10 are formed with a predetermined spacing at a direction vertical to the cathode 6 to offer a striped pattern.

The electron emission source 12 is formed on the cathode 6 and between the holes 8a and 10a. Of course, the shape of the electron emission source is not limited by the drawing. For example, it may have a conical shape.

The electron emission source 12 emits electrons by an electric field distribution formed between the cathode 6 and the gate electrode 10 due to a voltage applied to the cathode 6 and the gate electrode 10 from outside of the vacuum container 30.

The construction of the electron emission source of the present invention is not limited to the above description. For example, the first substrate, or cathode substrate, may be formed on the gate electrode. Then, the cathode may be formed on the gate electrode with the insulating layer between them.

The following examples illustrate the present invention in more detail. However, it is understood that the present invention is not limited by these examples.

### EXAMPLES

### Comparative Example 1

2.5 g carbon nanotube powder was mixed with 0.5 g glass frit (8000 L glass frit) and filled in a ball mill container to about ⅓ and then crushed. 20 g methacryl polymer, 20 g trimethylolpropane triacrylate, 2 g 2,2-dimethoxy-2-phenylacetophenone, 1.4 g isopropyl thioxantone and 30 g ethylcarbitol acetate were mixed, crushed, and then added to the mixture. The resultant mixture was stirred to obtain a photosensitive carbon nanotube paste composition. The prepared photosensitive carbon nanotube paste composition was printed and exposed with a parallel exposer at an exposure energy of 1,000 mJ/cm². the resultant carbon nanotube paste was sintered to obtain an electron emission source.

### Example 1

An electron emission source was prepared as in comparative Example 1, except 4 g vinyltrimethoxyethoxysilane was used in place of glass frit.

### Example 2

An electron emission source was prepared as in Comparative Example 1, except 4 g vinyltrimethylsilane was used in place of glass frit.

### Example 3

An electron emission source was prepared as in Comparative Example 1, except 4 g vinyltrimethoxysilane was used in place of glass frit.

### Example 4

An electron emission source was prepared as in Comparative Example 1, except 4 g vinyltriethoxysilane was used in place of glass frit.

### Example 5

An electron emission source was prepared as in Comparative Example 1, except 4 g vinyltrichlorosilane was used in place of glass frit.

### Example 6

An electron emission source was prepared as in Comparative Example 1, except 4 g γ-methacryloxypropyltrimethoxysilane was used in place of glass frit.

### Example 7

An electron emission source was prepared as in Comparative Example 1, except 4 g 2-(3,4-epoxycyclohexyl)ethyl-trimethoxysilane was used in place of glass frit.

### Example 8

An electron emission source was prepared as in Comparative Example 1, except 4 g N-aminoethyl-aminopropyl-trimethoxysilane was used in place of glass frit.

The emission current density (μA/cm²) of each electron emission source prepared in Comparative Example 1 and Examples 1 to 3 was measured. The results are shown in Table 1.

The adhesive force of each electron emission source prepared in Comparative Example 1 and Examples 1 to 3 was measured by attaching a 1.5×1.5 cm piece of Scotch tape (3M) to each electron emission source at room temperature. The tape was detached at a velocity of 0.5 cm/s. Then, the amount of carbon nanotube powder attached to the tape was measured. The greater the amount of carbon nanotube powder, the poorer the adhesive force. The results are shown in Table 1.

TABLE 1

| | Strength of electric field | | | | |
|---|---|---|---|---|---|
| Classification | 3 V/μm | 5 V/μm | 7 V/μm | 9 V/μm | Adhesive force* |
| Comparative | 5 | 35 | 220 | 630 | z |
| Example 1 | | | | | |
| Example 1 | 25 | 100 | 600 | 1400 | x |
| Example 2 | 30 | 115 | 650 | 1550 | y |
| Example 3 | 27 | 110 | 630 | 1500 | y |

*Adhesive force ratings: x = very superior; y = superior; z = moderate

As seen in Table 1, the electron emission sources prepared in Examples 1 to 3 showed better electron emission characteristics (luminance) than that of Comparative Example 1. Also, they showed better adhesive force than that of Comparative Example 1.

Because the composition for forming an electron emission source for an electron emission device according to the present invention comprises a silane-based compound, its adhesive force to the substrate after exposure and development is improved, thereby offering a uniform exposure pattern and improved field emission effect and emission current of the device.

While the present invention has been described in detail with reference to the preferred embodiments, those skilled in the art will appreciate that various modifications and substitutions can be made thereto without departing from the spirit and scope of the present invention as set forth in the appended claims.

1. A composition for forming an electron emission source comprising:
an organic binder resin;
a carbon-based material;
a solvent; and
a silane-based compound represented by the following Formula 1:
R′—SiR₃
where R is selected from the group consisting of alkoxy, alkyls, chloro, fluoro and bromo and R′ is selected from the group consisting of vinyl, epoxy, methacryl, amino, mercapto and 2-(3,4-epoxycyclohexyl)ethyl.

2. The composition of claim 1, wherein the carbon-based material comprises a material selected from the group consisting of carbon nanotube, graphite, diamond, diamond-like carbon, fullerene and combinations thereof.

3. The composition of claim 1, wherein the silane-based compound comprises a compound selected from the group consisting of vinyltrimethoxyethoxysilane, vinyltrimethylsilane, vinyltrimethoxysilane, vinyltriethoxysilane, ethyltrichlorosilane, vinyltrichlorosilane, γ-methacryloxypropyltrimethoxysilane, γ-methacryloxypropylmethyldimethoxysilane, γ-aminopropyltriethoxysilane, N-aminoethyl-aminopropyl-trimethoxysilane, 2-)3,4-epoxycyclohexyl)ethyl-trimethoxysilane, N-aminoethyl-aminopropyl-trimethoxysilane, 2-(3,4-epoxycyclohexyl)ethyltrimethyoxysilane, vinyl-tris(2-methoxyethoxy)-silane and combinations thereof.

4. The composition of claim 1, wherein the organic binder resin is present in an amount ranging from 5 to 60 parts by weight based on the total weight of the composition, the carbon-based material is present in an amount ranging from 1 to 20 parts by weight based on the total weight of the composition, the solvent is present in an amount ranging from 30 to 60 parts by weight based on the total weight of the composition, and the silane-based compound is present in an amount ranging from 0.1 to 20 parts by weight based on the total weight of the composition.

5. The composition of claim 1, wherein the organic binder resin is present in an amount ranging from 5 to 60 parts by weight based on the total weight of the composition, the carbon-based material is present in an amount ranging from 1 to 20 parts by weight based on the total weight of the composition, the solvent is present in an amount ranging from 30 to 60 parts by weight based on the total weight of the composition, and the silane-based compound is present in an amount ranging from 0.1 to 10 parts by weight based on the total weight of the composition.

6. The composition of claim 1, further comprising glass frit.

7. A composition for forming an electron emission source comprising:
a carbon-based material;
a solvent;
a photosensitive component selected from the group consisting of photosensitive monomers, oligomers and polymers;
a photoinitiator; and
a silane-based compound represented by the following Formula 1:
R′—SiR₃
where R is selected from the group consisting of alkoxys, alkyls, chloro, fluoro and bromo and R′ is selected from the group consisting of vinyl, epoxy, methacryl, amino, mercapto and 2-(3,4-epoxycyclohexyl)ethyl.

8. The composition of claim 7, wherein the carbon-based material comprises a material selected from the group consisting of carbon nanotube, graphite, diamond, diamond-like carbon, fullerene and combinations thereof.

9. The composition of claim 7, wherein the silane-based compound comprises a compound selected from the group consisting of vinyltrimethoxyethoxysilane, vinyltrimethylsilane, vinyltrimethoxysilane, vinyltriethoxysilane, ethyltrichlorosilane, vinyltrichlorosilane, γ-methacryloxypropyltrimethoxysilane, γ-methacryloxypropylmethyldimethoxysilane, γ-aminopropyltriethoxysilane, N-aminoethyl-aminopropyl-trimethoxysilane, 2-)3,4-epoxycyclohexyl)ethyl-trimethoxysilane, N-aminoethyl-aminopropyl-trimethoxysilane, 2-(3,4-epoxycyclohexyl)ethyltrimethyoxysilane, vinyl-tris(2-methoxyethoxy)-silane and combinations thereof.

10. The composition of claim 7, wherein the carbon-based material is present in an amount ranging from 1 to 20 parts by weight based on the total weight of the composition, the photosensitive component is present in an amount ranging from 5 to 60 parts by weight based on the total weight of the composition, the solvent is present in an amount ranging from 30 to 60 parts by weight based on the total weight of the composition, and the silane-based compound is present in an amount ranging from 0.1 to 20 parts by weight based on the total weight of the composition.

11. The composition of claim 7, wherein the carbon-based material is present in an amount ranging from 1 to 20 parts by weight based on the total weight of the composition, the photosensitive component is present in an amount ranging from 5 to 60 parts by weight based on the total weight of the composition, the solvent is present in an amount ranging from 30 to 60 parts by weight based on the total weight of the composition, and the silane-based compound is present in an amount ranging from 0.1 to 10 parts by weight based on the total weight of the composition.

12. The composition of claim 7, further comprising glass frit.

13. The composition of claim 7, wherein the photosensitive component is selected from the group consisting of photosensitive oligomers and photosensitive polymers formed by the polymerization of compounds having unsaturated carbon-carbon bonds, and the photosensitive component has a weight-average molecular weight ranging from 500 to 100,000.

14. The composition of claim 7, wherein the photosensitive component is based on an acrylate-based monomer.

15. The composition of claim 14, wherein the acrylate based monomer comprises a monomer selected from the group consisting of epoxy acrylate, polyester acrylate, methyl acrylate, ethyl acrylate, n-propyl acrylate, isopropyl acrylate, n-butyl acrylate, sec-butyl acrylate, iso-butyl acrylate, tert-butyl acrylate, n-pentyl acrylate, allyl acrylate, benzyl acrylate, butoxyethyl acrylate, butoxytriethylene glycol acrylate, cyclohexyl acrylate, dicyclopentanyl acrylate, dicyclopentenyl acrylate, 2-ethylhexyl acrylate, glycerol acrylate, glycidyl acrylate, heptadecafluorodecyl acrylate, 2-hydroxyethyl acrylate, isobornyl acrylate, 2-hydroxypropyl acrylate, isodexyl acrylate, isooctyl acrylate, lauryl acrylate, 2-methoxyethyl acrylate, methoxyethylene glycol acrylate, methoxydiethylene glycol acrylate and combinations thereof.

16. The composition of claim 7, wherein the photoinitiator comprises a compound selected from the group consisting of benzophenone, methyl-o-benzoyl benzoate, 4,4-bis(dimethylamino)benzophenone, 4,4-bis(diethylamino)benzophenone, 4,4-dichlorobenzophenone, 4-benzoyl-4-methyldiphenyl ketone, dibenzyl ketone, fluorenone, 2,2-diethoxyacetophenone, 2,2-dimethoxy-2-phenylacetophenone, 2-hydroxy-2-methylpropiophenone, p-t-butyldichloroacetophenone, thioxantone, 2-methylthioxantone, 2-chlorothioxantone, 2-isopropylthioxantone, diethylthioxantone, benzyl dimethyl ketanol, benzyl methoxyethyl acetal, benzoin, benzoin methyl ether, benzoin butyl ether, anthraquinone, 2-t-butyl anthraquinone, 2-amylanthraquinone, β-chloroanthraquinone, anthrone, benzathrone, dibenzosverone, methylene anthrone, 4-azidebenzalacetophenone, 2,6-bis(p-azidebenzylidene)cyclohexanone, 2,6-bis(p-azidebenzylidene)-4-methylcyclohexanone, 2-phenyl-1,2-butadione-2-(o-methoxycarbonyl)oxime, 2,3-bis(4-diethylaminobenzal)cyclopentanone, 2,6-bis(4-dimethylaminobenzal)cyclohexanone, 2,6-bis(4-dimethylaminobenzal)-4-methylcyclohexanone, Mihira ketone, 4,4-bis(diethylamino)-benzophenone, 4,4-bis(dimethylamino)chalcone, 4,4-bis(diethylamino)chalcone, p-dimethylaminocynnamilidene indanone, p-dimethylaminobenzylidene indanone, 2-(p-dimethylaminophenylvinylene)-isonaphtothiazole, 1,3-bis(4-dimethylaminobenzal)acetone, 1,3-carbonyl-bis(4-diethylaminobenzal)acetone, 3,3-carbonyl-bis(7-diethylaminocumaline), N-phenyl-N-ethylethanolamine, N-phenylethanolamine, N-tolyldiethanolamine, N-phenylethanolamine, isoamyl dimethylaminobenzoate, isoamyl diethylaminobenzoate, 3-phenyl-5-benzoylthio-tetrazol, 1-phenyl-5-ethoxycarbonylthio-tetrazol and combinations thereof.

17. An electron emission source prepared by printing a composition according to claim 1.

18. An electron emission device comprising the electron emission source of claim 17.

19. The electron emission device of claim 18, wherein the electron emission device is a field emission display.

20. An electron emission device comprising:
first and second substrates facing each other, aligned a predetermined distance from one another and forming a vacuum container;
an electron emission source formed from a composition according to claim 1, the electron emission source being located on the first substrate;
an anode formed on the second substrate and facing the first substrate;
a patterned fluorescent film on the anode for emitting electrons from the electron emission source; and
a patterned black matrix layer on the anode.
